(19) United States
(12) Patent Application Publication
(10) Pub. No.: US 2013/0219669 A1
(43) Pub. Date: Aug. 29, 2013

(54) Loop Suspension System

(71) Applicant: Chien-Chih Lin, Changhua (TW)

(72) Inventor: Chien-Chih Lin, Changhua (TW)

(21) Appl. No.: 13/726,513

(22) Filed: Dec. 24, 2012

Related U.S. Application Data
(60) Provisional application No. 61/579,664, filed on Dec. 23, 2011.

(51) Int. Cl. F16G 11/14

(52) U.S. Cl. CPC F16G 11/14
USPC 24/115 H

(57) ABSTRACT

A suspension system has a housing with an elongated aperture that has first and second coaxial aperture portions. The second aperture portion has a dimension that diminishes along an axis. A unidirectional clutch is contained within the elongated aperture, and is provided with first and second axially aligned clutch portions. The second clutch portion has a dimension that diminishes along an axis of the first unidirectional clutch arrangement. A gripper ball is disposed in the second clutch portion and communicates with the second aperture portion of the housing. The gripper ball is urged toward the axis of the first unidirectional clutch arrangement to grip a cable. A spring resiliently urges the first unidirectional clutch arrangement toward the second aperture portion. An end cap with an aperture is affixed to the first coaxial aperture portion for forming a back stop for the spring.

### RELATIONSHIP TO OTHER APPLICATION

This application claims the benefit of the filing date of U.S. Provisional Patent Application Ser. No. 61/579,664 filed on Dec. 23, 2011. The disclosure in that provisional patent application is incorporated herein by reference to the fullest extent permitted under the law.

### BACKGROUND OF THE INVENTION

### Field of the Invention

This invention relates generally to arrangements for suspending items from above, and more particularly, to a suspension arrangement that supports items in suspension at an easily adjustable distance.

### SUMMARY OF THE INVENTION

The invention provides a suspension system having a housing having an elongated aperture therethrough. The elongated aperture has first and second coaxial aperture portions, the second aperture portion having a cross-sectional dimension that diminishes at a determined rate along an axis of the elongated aperture. There is additionally provided a first unidirectional clutch arrangement contained within the elongated aperture through the housing. The first unidirectional clutch arrangement has first and second axially aligned clutch portions, the second clutch portion having a cross-sectional dimension that diminishes at a determined rate along an axis of the first unidirectional clutch arrangement. A gripper element is disposed in the second clutch portion and is arranged to communicate with the second aperture portion of the housing and be urged thereby toward the axis of the first unidirectional clutch arrangement. Additionally, a resilient element resiliently urges the first unidirectional clutch arrangement toward the second aperture portion.

In one embodiment, the gripper element has a spherical configuration. In some embodiments, there are provided a plurality of the spherically configured gripper elements distributed concentrically around the second clutch portion.

In a further embodiment, there is provided an end cap for forming a back stop for the resilient element. The end cap has an aperture therethrough that, in some embodiments, is coaxially arranged with the axis of the elongated aperture. Any known form of affixation can be used to secure the end cap to the housing. However, in an advantageous embodiment, the end cap is inserted into the first aperture portion of the housing using an interference fit.

In a highly advantageous embodiment of the invention, the housing has a second elongated aperture therethrough that has first and second coaxial aperture portions. The second aperture portion has a cross-sectional dimension that diminishes at a determined rate along an axis of the second elongated aperture. There is additionally provided a second unidirectional clutch arrangement contained within the second elongated aperture through the housing. The second unidirectional clutch arrangement has first and second axially aligned clutch portions, the second clutch portion having a cross-sectional dimension that diminishes at a determined rate along an axis of the second unidirectional clutch arrangement. There is additionally provided in this embodiment of the invention a further gripper element that is disposed in the second clutch portion of the second unidirectional clutch arrangement and is arranged to communicate with the second aperture portion of the second elongated aperture of the housing. The further gripper element is urged thereby toward the axis of the second unidirectional clutch arrangement. A further resilient element resiliently urges the second unidirectional clutch arrangement toward the second aperture portion of the second elongated aperture.

In some embodiments, the axis of the elongated aperture and the axis of the second elongated aperture are substantially parallel to each other, and the first and second unidirectional clutch arrangements are oriented on their respective axes in opposing directions.

In a further embodiment, there is provided a suspension cable disposed through the first unidirectional clutch arrangement. The suspension cable communicates with the gripper element.

In some embodiments of the invention, there is provided a hook coupled to the housing in the vicinity of the second aperture portion. In some such embodiments, there is additionally provided a third aperture portion extending transaxially through which excess cable is passed.

In accordance with a further system aspect of the invention, there is provided a suspension system having a housing that has an elongated aperture therethrough. The elongated aperture has first and second coaxial aperture portions, the second aperture portion having a cross-sectional dimension that diminishes at a determined rate along an axis of the elongated aperture. A first unidirectional clutch arrangement is contained within the elongated aperture through the housing, and is provided with first and second axially aligned clutch portions. The second clutch portion has a cross-sectional dimension that diminishes at a determined rate along an axis of the first unidirectional clutch arrangement. A gripper ball is disposed in the second clutch portion and is arranged to communicate with the second aperture portion of the housing. The gripper ball is urged thereby toward the axis of the first unidirectional clutch arrangement. A spring resiliently urges the first unidirectional clutch arrangement toward the second aperture portion. Also, an end cap is affixed to the first coaxial aperture portion for forming a back stop for the spring. The end cap has an aperture therethrough.

The present invention is an adjustable cable loop device that is used to suspend cable trays, lighting systems, ceiling panels, or signage.

By making loops, one can complete a ceiling installation job easily, including, for example, marketing displays, without the need for professional installers.

In use, one simply inserts a suspension cable into an arrow-guided clutch. A built-in locking mechanism grips the suspension cable automatically. To release, one simply presses a clutch release button, and the suspension cable is freed to move back and forth to achieve any desired length.

In a specific illustrative embodiment of the invention, aluminum alloy is employed as the base material. This material is light in weight and eco-friendly. The casing, in one embodiment of the invention, is formed of anodized aluminum, allowing for a wide range of colors, including black, and also provides protection against corrosion.

### BRIEF DESCRIPTION OF THE DRAWINGS

Comprehension of the invention is facilitated by reading the following detailed description, in conjunction with the annexed drawing, in which:

FIG. 1 is an isometric representation of a specific illustrative embodiment of the invention;

FIGS. 2(a), 2(b), 2(c), and 2(d) illustrate respective modes of insertion of one or more suspension cables to form suspension loops, using the embodiment of FIG. 1;

FIG. 3 is a simplified schematic isometric exploded representation of a specific illustrative embodiment of the invention;

FIGS. 4(a), 4(b), 4(c), 4(d), and 4(e) are respective simplified schematic representations of an embodiment of the invention showing the formation of a cable loop;

FIGS. 5(a) through 5(j) are respective representations of ten embodiments of the invention and associated cable arrangements that are useful as illustrative embodiments;

FIGS. 6(a) through 6(j) are representations of nine cable arrangements that can be used in the illustrative embodiment, as well as a cable cutting tool; and

FIG. 7 is a simplified perspective representation of an installation of suspended items using the present invention.

### DETAILED DESCRIPTION

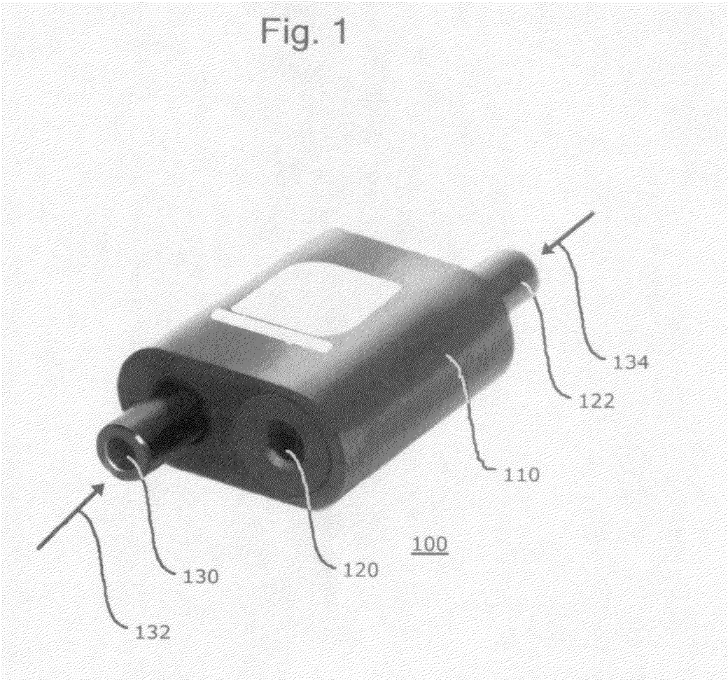

FIG. 1 is an isometric representation of a specific illustrative embodiment of a cable gripper assembly 100 constructed in accordance with the invention. Arrows 132 and 134 illustrate the direction in which a suspension cable (not shown in this figure) is entered into gripper body 110 of cable gripper assembly 100. In this specific illustrative embodiment of the invention, a suspension cable that would enter at cable inlet/clutch 122 in the direction of arrow 134 would exit from a cable outlet 120. Similarly, a suspension cable that would enter at cable inlet/clutch 130 in the direction of arrow 132 would exit from a cable outlet that is not shown in this figure, but in this embodiment of the invention, the unseen cable outlet is similar to cable outlet 120.

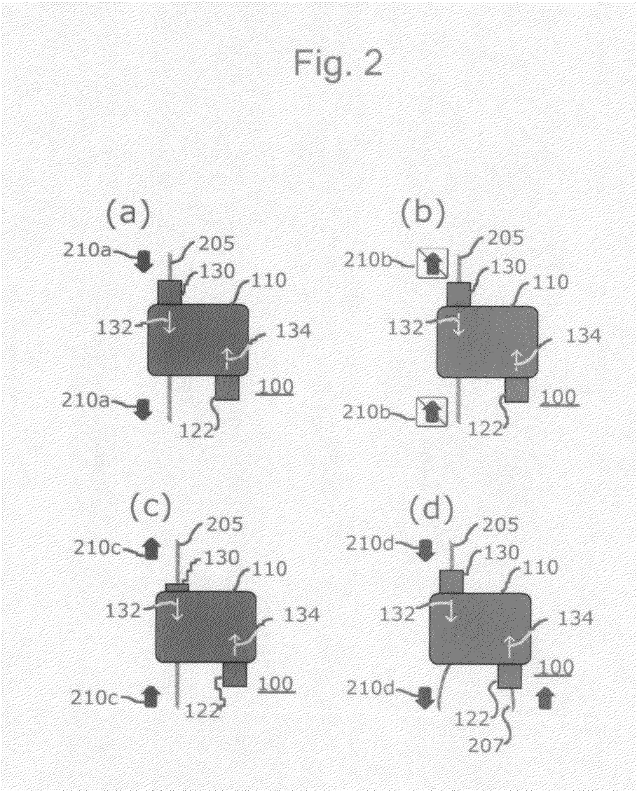

FIGS. 2(a), 2(b), 2(c), and 2(d) illustrate respective modes of insertion of one or more suspension cables to form suspension loops (not shown), using cable gripper assembly 100, which is the embodiment of FIG. 1. Elements of structure that have previously been discussed are similarly designated. As shown in FIG. 2(a), a suspension cable 205 enters cable inlet/clutch 130 in the direction of arrow 132. Arrows 210a show that suspension cable 205 enters freely is the specified direction. However, suspension cable 205 is not freely displaceable in a direction opposite to the direction of arrow 210a. FIG. 2(b), which corresponds in significant measure to the representation of FIG. 2(a), illustrates by arrows 210b that suspension cable 205 does not move freely in the axial direction of arrows 210b.

FIG. 2(c) is a representation of the embodiment of FIG. 1 showing that by urging cable inlet/clutch 130 inward (in the direction of arrow 132), the suspension cable is released to move freely in the direction of arrows 210c. This feature facilitates adjustment of the location along suspension cable 205 where gripper body 110 is fixed to support a suspended item (not shown), as will be discussed below.

FIG. 2(d) is a representation of the embodiment of FIG. 1 showing that a suspension cable 207 is in this embodiment of the invention inserted into cable inlet/clutch 122. Suspension cable 207 can, in some embodiments be en extension of suspension cable 205, whereby an adjustable loop is formed. In this specific illustrative embodiment of the invention cable inlet/clutch 122 functions in the same manner as cable inlet/clutch 130. In other embodiments, the second cable inlet/clutch 122 is replaced by a cable affixation clamp (not shown) or in other embodiments is not provided at all.

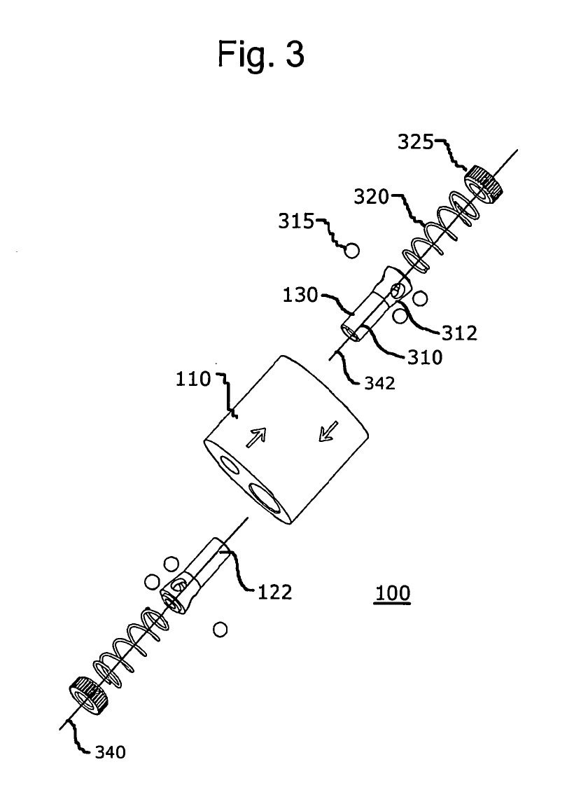

FIG. 3 is a simplified schematic isometric exploded representation of cable gripper assembly 100, including gripper body 110 and its internal components. Elements of structure that have previously been discussed are similarly designated. Gripper body 110 has, in this specific illustrative embodiment of the invention, a length of approximately 20 mm, and a width also of approximately 20 mm. In an advantageous embodiment, gripper body 110 is formed of aluminum with an anodized finish. As seen in this figure, cable inlet/clutch 130 has a tubular portion 310 that is axially aligned with a tapered portion 312 to form the cable inlet/clutch that in this embodiment has an overall length of approximately 13.5 mm. Tapered portion 312 has apertures that accommodate gripper balls 315. In this embodiment, gripper balls 315 have a diameter dimension of approximately 2.4 mm. In an advantageous embodiment of the invention, cable inlet/clutch 130 is formed of brass with a zinc finish, and gripper balls 315 are formed of steel with a raw finish.

Axially aligned with cable inlet/clutch 130 is a compression spring 320 that in this specific illustrative embodiment of the invention is formed of a steel wire with a zinc finish, and has a wire diameter of approximately 0.4 mm. The spring is axially followed by an end cap 325 having, in this embodiment, a diameter of approximately 6.55 mm and an axial length of approximately 2.7 mm. End cap 325 is, in this embodiment, formed of aluminum with a raw finish, and forms a back stop for compression spring 320. Any known form of engagement, such as threaded engagement or interference fit can be used in the practice of the invention to secure end cap 325 in the corresponding opening in gripper body 110 (not specifically designated), as will be discussed below.

When cable inlet/clutch 130 is pushed in to release suspension cable 205, as described hereinabove in relation to FIG. 2(c), tapered portion 312 is urged axially against, and compresses, compression spring 320.

Further in regard of FIG. 3, there is shown an additional cable inlet/clutch 122 that in this specific illustrative embodiment of the invention is identical to cable inlet/clutch 130. As shown, cable inlet/clutch 122 has a central axis 340 that is parallel to a central axis 342 of cable inlet/clutch 130. The respective cable inlet/clutches are oriented on their respective central axes in opposing directions.

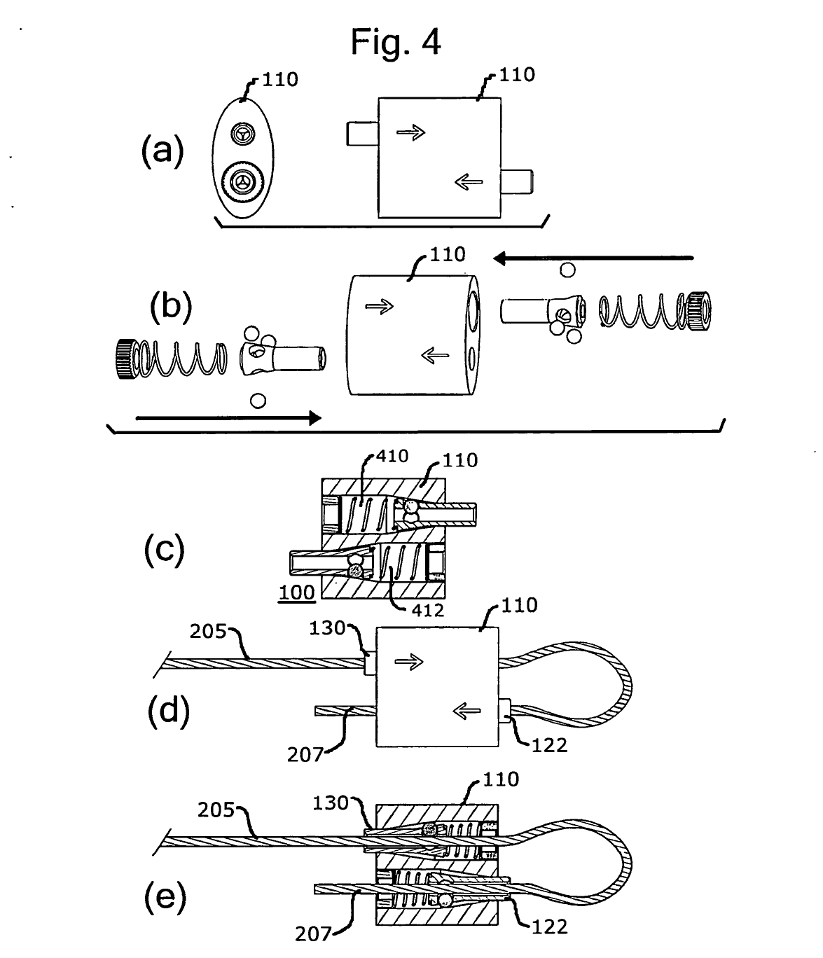

FIGS. 4(a) to 4(e) are respective simplified schematic representations of an embodiment of the invention showing the formation of a cable loop. Elements of structure that have previously been discussed are similarly designated. FIG. 4(a) shows plan and end representations of cable gripper assembly 100, particularly gripper body 110. FIG. 4(b) is an exploded plan representation of cable gripper assembly 100, including gripper body 110 and its internal components. This figure corresponds to the exploded isometric representation of FIG. 3.

FIG. 4(c) is a cross-sectional plan representation of cable gripper assembly 100, including gripper body 110 and its internal components in an assembled condition. It is seen from this figure that gripper body 110 has apertures 410 and 412 therethrough that are tapered to conform to the tapered portions of the cable inlet/clutches (not specifically designated in this figure). when the springs (not specifically designated in this figure) urge the cable inlet/clutches toward communication between the tapered portions of the cable inlet/clutches and the tapered portions of the apertures of the gripper body. This causes a consequent urging of the gripper balls (not specifically designated in this figure) radially inward. As will be discussed below in relation to FIG. 4(e), the radially inward urging of the gripper balls serves to grip the suspension cable unidirectionally.

FIG. 4(d) is a plan representation of cable gripper assembly 100 after formation of a loop of suspension cable 205. The loop, in this embodiment of the invention, is formed by the insertion of cable end 207 through cable inlet/clutches 122 and 310.

FIG. 4(e) is a plan cross-sectional representation of the arrangement of FIG. 4d, and provides an illustration of the manner by which the suspension cable is gripped unidirectionally by gripper body 110. It is seen from this drawing that the gripper balls are urged into communication with the suspension cable when the springs (not specifically designated in this figure) urge the cable inlet/clutches toward communication between the tapered portions of the cable inlet/clutches and the tapered portions of the apertures of the gripper body. However, if the suspension cable is urged in the direction where the tapered portions of the suspension cable inlet/clutches and the tapered portions of the apertures of the gripper body are urged axially away from one another, then the gripper balls release the suspension cable allowing for adjustment of the cable length.

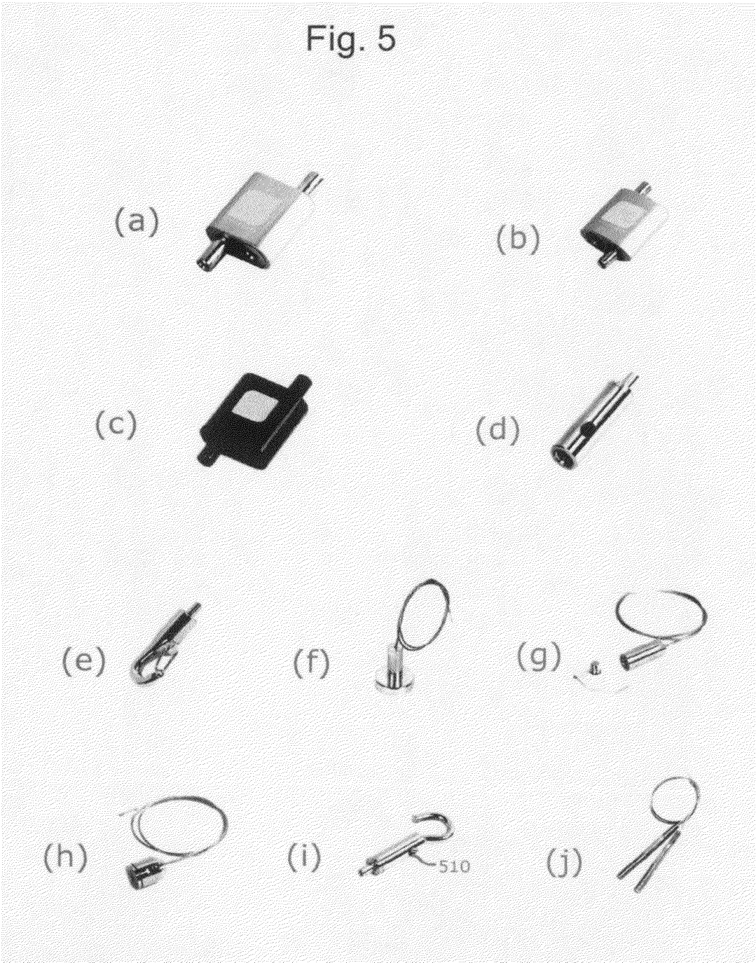

FIGS. 5(a) through 5(j) are representations of ten respective embodiments of the invention and associated cable arrangements that are useful as illustrative embodiments. FIG. 5(a) is an isometric representation of an illustrative embodiment of the invention for use with 3.0 mm cable (not shown). This embodiment of the invention is suitable for loads on the order of up to 90 kg. FIG. 5(b) is an isometric representation of an illustrative embodiment of the invention for use with 1.5 mm cable (not shown). This embodiment of the invention is suitable for loads on the order of up to 20 kg.

FIG. 5(c) is an isometric representation of an illustrative embodiment of the invention for use with 3.0 mm cable (not shown). This embodiment of the invention is suitable for loads on the order of up to 90 kg. In addition, this specific illustrative embodiment of the invention is formed of an aluminum body that has been annealed. A number of corrosion resistant finishes can be achieved with the annealing process.

FIG. 5(d) is an isometric representation of a single gripper embodiment of the invention. This embodiment is provided with a threaded section that can be used with a magnetic anchor (not shown) or a ceiling clip (not shown).

FIG. 5(e) is an isometric representation of a hook that is useful for hanging pictures, paintings, signage, etc. This embodiment is additionally provided with a single gripper (not shown) that functions as an adjustment clutch.

FIG. 5(f) is an isometric representation of a magnetic anchor that is useful in the practice of the invention. In this embodiment, the magnetic anchor will support up to approximately 500 g and is useful for attaching to the metal grid of a ceiling (not shown) for hanging display posters or other signage, for example. Any of the gripper assemblies herein described, particularly the single gripper embodiments, can be used with the suspension cable that is shown to be attached to the magnetic anchor. FIG. 5(g) is an isometric representation of a ceiling twister clip that is attached to a ceiling with a simple twist motion whereby it is locked in place on the metal grid of a ceiling. Again, any of the gripper assemblies herein described can be used with the ceiling twister clip.

FIG. 5(h) is an isometric representation of a wall or ceiling anchor that is useful in the practice of the invention. This anchor allows the suspension cable to move over a range of 180°. FIG. 5(I) is an isometric representation of a gripper hook that is provided in some embodiments with a gripper clutch that functions as hereinabove described. It is seen in this figure that there is provided an exit aperture 510 that directs excess cable (not shown) in a direction away from the axis (not shown) of the gripper hook.

FIG. 5(j) is an isometric representation of a Y-split bolt that is useful in the practice of the invention to support cable trays or lighting fixtures (not shown). The Y suspension facilitates balancing of the load.

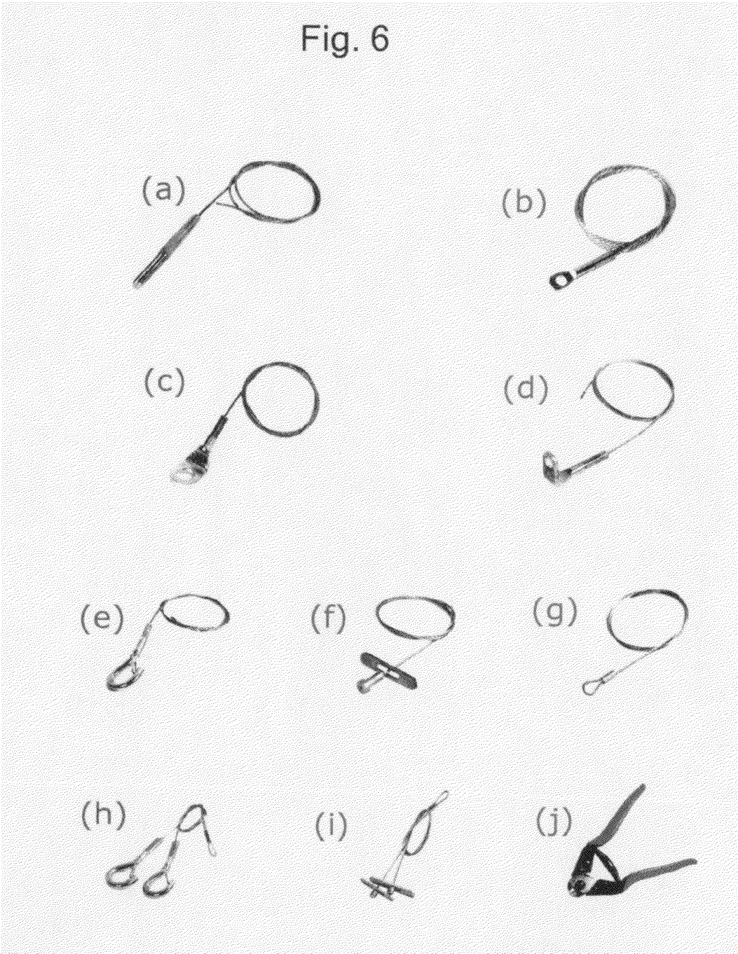

FIGS. 6(a) through 6(j) are representations of nine suspension cable arrangements that can be used in the illustrative embodiment, as well as a cable cutting tool. FIG. 6(a) is an isometric representation of a cable bolt that works with ceiling anchors (not shown), expansion bolts (not shown), and thread nut fixtures (not shown) that can be used with various suspension cable diameters. FIG. 6(b) is an isometric representation of a suspension cable eyelet that has a hole therethrough and an in-line cable. FIG. 6(c) is an isometric representation of a cable eyelet that has a hole therethrough at an angle of 45° and also has an in-line cable. The 45° angle facilitates affixation to angled surfaces. FIG. 6(d) is an isometric representation of a cable eyelet that has a hole therethrough at an angle of 90° and also has an in-line cable. The 90° angle facilitates affixation to surfaces that are perpendicular to the suspension cable.

FIG. 6(e) is an isometric representation of a hook that is useful for hanging pictures, paintings, signage, etc. and also has an in-line cable. FIG. 6(f) is isometric representation of a toggle that is useful to support items (not shown) where only a small opening is available to slide the toggle through, but not large enough to accommodate a hook. FIG. 6(g) is an isometric representation of a small loop disposed at one end of a cable, that is useful to tie-off support members (not shown in this figure). FIG. 6(h) is an isometric representation of a Y splitter with spring hooks on the ends of the cables. This arrangement is useful for supporting a basket tray or the body of a light fixture. FIG. 6(I) is an isometric representation of a Y splitter with toggle hooks on the ends of the cables. This arrangement is useful for supporting a basket tray or the body of a light fixture using openings that are too small to accommodate hooks.

FIG. 6(j) is an isometric representation of a cable cutter tool that is useful in a kit that would include bulk cable (not shown) that would be cut to specified length for an installation project for suspending items.

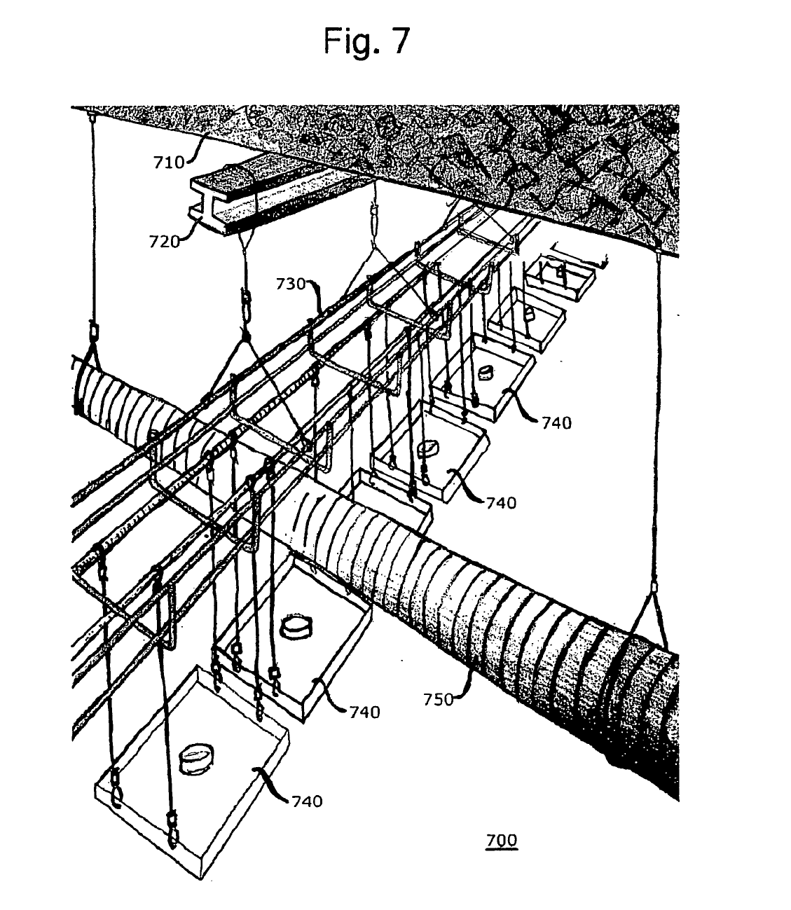

FIG. 7 is a simplified perspective representation of an installation 700 of suspended items using multiple embodiments of the present invention. As shown in this figure, a ceiling 710 supports a suspended support beam 720 that itself supports a suspended cable tray 730 and a plurality of suspended lighting fixtures 740. In this specific illustrative embodiment of the invention, ceiling 710 additionally supports a suspended air duct 750.

Although the invention has been described in terms of specific embodiments and applications, persons skilled in the art can, in light of this teaching, generate additional embodiments without exceeding the scope or departing from the spirit of the invention described and claimed herein. Accordingly, it is to be understood that the drawing and description in this disclosure are proffered to facilitate comprehension of the invention, and should not be construed to limit the scope thereof.

What is claimed is:

1. A suspension system comprising:
a housing having an elongated aperture therethrough, the elongated aperture having first and second coaxial aperture portions, the second aperture portion having a cross-sectional dimension that diminishes at a determined rate along an axis of the elongated aperture;
a first unidirectional clutch arrangement contained within the elongated aperture through said housing, said first unidirectional clutch arrangement having first and second axially aligned clutch portions, the second clutch portion having a cross-sectional dimension that diminishes at a determined rate along an axis of the first unidirectional clutch arrangement;
a gripper element disposed in the second clutch portion and arranged to communicate with the second aperture portion of said housing and be urged thereby toward the axis of the first unidirectional clutch arrangement; and
a resilient element for resiliently urging said first unidirectional clutch arrangement toward the second aperture portion.

2. The system of claim 1, wherein said gripper element has a spherical configuration.

3. The system of claim 2, wherein there are provided a plurality of said spherically configured gripper elements distributed concentrically around the second clutch portion.

4. The system of claim 1, wherein there is further provided an end cap for forming a back stop for said resilient element, said end cap having an aperture therethrough coaxially arranged with the axis of the elongated aperture.

5. The system of claim 4, wherein said end cap is inserted into the first aperture portion of said housing using an interference fit.

6. The system of claim 1, wherein said housing has a second elongated aperture therethrough, the second elongated aperture having first and second coaxial aperture portions, the second aperture portion having a cross-sectional dimension that diminishes at a determined rate along an axis of the second elongated aperture, and there are further provided:
a second unidirectional clutch arrangement contained within the second elongated aperture through said housing, said second unidirectional clutch arrangement having first and second axially aligned clutch portions, the second clutch portion having a cross-sectional dimension that diminishes at a determined rate along an axis of the second unidirectional clutch arrangement;
a further gripper element disposed in the second clutch portion of said second unidirectional clutch arrangement and arranged to communicate with the second aperture portion of the second elongated aperture of said housing and be urged thereby toward the axis of the second unidirectional clutch arrangement; and
a further resilient element for resiliently urging said second unidirectional clutch arrangement toward the second aperture portion of the second elongated aperture.

7. The system of claim 6, wherein the axis of the elongated aperture and the axis of the second elongated aperture are substantially parallel to each other, and said first and second unidirectional clutch arrangements are oriented on their respective axes in opposing directions.

8. The system of claim 4, wherein there is further provided a suspension cable disposed through said first unidirectional clutch arrangement and communicating with said gripper element.

9. The system of claim 1, wherein there is further provided a hook coupled to said housing in the vicinity of the second aperture portion.

10. The system of claim 9, wherein there is further provided a third aperture portion extending transaxially.

11. A suspension system comprising:
a housing having an elongated aperture therethrough, the elongated aperture having first and second coaxial aperture portions, the second aperture portion having a cross-sectional dimension that diminishes at a determined rate along an axis of the elongated aperture;
a first unidirectional clutch arrangement contained within the elongated aperture through said housing, said first unidirectional clutch arrangement having first and second axially aligned clutch portions, the second clutch portion having a cross-sectional dimension that diminishes at a determined rate along an axis of the first unidirectional clutch arrangement;
a gripper ball disposed in the second clutch portion and arranged to communicate with the second aperture portion of said housing and be urged thereby toward the axis of the first unidirectional clutch arrangement;
a spring for resiliently urging said first unidirectional clutch arrangement toward the second aperture portion; and
an end cap affixed to the first coaxial aperture portion for forming a back stop for said spring, said end cap having an aperture therethrough.
